(19) United States
(12) Patent Application Publication
(10) Pub. No.: US 2012/0092274 A1
(43) Pub. Date: Apr. 19, 2012

(54) TOUCH SCREEN

(75) Inventors: Hyun Jun Kim, Gyunggi-do (KR); Yong Soo Oh, Gyunggi-do (KR); Jong Young Lee, Gyunggi-do (KR); Jae Il Kim, Gyunggi-do (KR); Woon Chun Kim, Gyunggi-do (KR)

(73) Assignee: SAMSUNG ELECTRO-MECHANICS CO., LTD., Gyunggi-do (KR)

(21) Appl. No.: 13/017,199

(22) Filed: Jan. 31, 2011

(30) Foreign Application Priority Data
Oct. 14, 2010 (KR) 1020100100492

(51) Int. Cl. G06F 3/041

(52) U.S. Cl. 345/173

(57) ABSTRACT

Disclosed herein is a touch screen, including: a first transparent electrode formed on one surface of a first transparent substrate; a second transparent electrode formed on one surface of a second transparent substrate; a first adhesive layer configured to adhere the first transparent substrate and the second transparent substrate to each other; a window plate adhered to the first transparent substrate; and hardness dots formed on one surface of the window plate or the other surface of the first transparent substrate. The present invention has been made in an effort to provide a touch screen which can lower the operational load of a transparent electrode.

### CROSS REFERENCE TO RELATED APPLICATION

This application claims the benefit of Korean Patent Application No. 10-2010-0100492, filed on Oct. 14, 2010, entitled “Touch screen”, which is hereby incorporated by reference in its entirety into this application.

### BACKGROUND OF THE INVENTION

1. Technical Field

The present invention relates to a touch screen.

2. Description of the Related Art

As electronic technology continuously develops, personal computers and portable transmitters etc. process texts and graphics, using a variety of input devices, such as a keyboard, a mouse, a digitizer, etc. These input devices, however, have been developed in consideration of the expanding usage of personal computers, such that they are difficult to be applied to portable devices that are recently reduced in size and thickness. Touch screens, devices generally installed in display devices to select users' desired information, have various advantages of being simply operated with little malfunction in a small space and very compatible with IT devices. Owing to these advantages, the touch screen is widely used in various fields such as industry, traffic, service, medicine, mobile, and the like.

Meanwhile, the touch screen is classifiable as a resistive type, a capacitive type, an electromagnetic type, a surface acoustic wave (SAW) type, an infrared type, and so on. Among others, the resistive type being relatively inexpensive and being able to accurately detect the positions of the touched input is widely used.

FIG. 1 is a cross-sectional view of a resistive-type touch screen 10 according to the prior art. The prior touch screen 10 is described with reference to this figure below.

As shown in FIG. 1, the touch screen 10 includes a transparent substrate 11, a transparent electrode 14, a double-sided adhesive tape (DAT) 17 and a dot spacer.

In this case, the transparent substrate 11 is configured of two sheets of an upper transparent substrate 12 and a lower transparent substrate 13, and the transparent electrode 14 is formed on one surface of the transparent substrate 11. Furthermore, the double-sided adhesive tape 17 is formed on the edge between the upper transparent substrate 12 and the lower transparent substrate 13 to adhere the upper transparent substrate 12 to the lower transparent substrate 13. Furthermore, the dot spacer 18 is formed on the lower transparent electrode 16.

However, the touch screen 10 according to the prior art has a problem in that even if touch input is applied and then the transparent electrode 15 is contacted with the lower transparent electrode 16, touch signals may not be detected. More particularly, although the upper transparent electrodes 15 are contacted with the lower transparent electrode 16, the contact signals can be detected only when force larger than a predetermined magnitude, that is, the force larger than an operational load is applied. There is a problem in that in order to apply the force above such an operational load, the large force must be applied to the touch input. Specifically, in the case where the transparent electrode 14 is made of conductive polymer, a problem occurs in that much larger operational load is required due to the flexibility of the conductive polymer.

Furthermore, when large force is pressed on the upper transparent substrate 12 in order to apply force higher than the operational load, a problem may occur in that the upper transparent substrate 12 is broken to damage the touch screen 10.

### SUMMARY OF THE INVENTION

The present invention has been made in an effort to provide a touch screen which can lower the operational load of a transparent electrode.

Further, the present invention has been made in an effort to provide a touch screen which lowers an operational load of a transparent electrode to previously prevent a touch input from being applied at large force thereto, thereby preventing damages in components.

A touch screen according to a preferred embodiment of the present invention includes: a first transparent electrode formed on one surface of a first transparent substrate; a second transparent electrode formed on one surface of a second transparent substrate; a first adhesive layer configured to adhere an edge of one surface of the first transparent substrate and an edge of one surface of the second transparent substrate to each other; a second adhesive layer formed on the other surface of the first transparent substrate; a window plate adhered to the first transparent substrate through the second adhesive layer; and hardness dots formed on one surface of the window plate adhered to the second adhesive layer or the other surface of the first transparent substrate, wherein the first transparent electrode and the second transparent electrode are contacted with each other upon occurrence of touch input, and sense changes in resistance or voltage, wherein the first transparent electrode and the second transparent electrode are contacted with each other upon occurrence of touch input, and sense changes in resistance or voltage.

The touch screen may further include dot spacers formed between the first transparent electrode and the second transparent electrode.

The first transparent electrode or the second transparent electrode may include a conductive polymer.

The hardness dots and the dot spacers may be alternately arranged.

The dot spacers may be formed on the first transparent electrode or the second transparent electrode.

### BRIEF DESCRIPTION OF THE DRAWINGS

FIG. 1 is a cross-sectional view of a touch screen according to the prior art;

FIG. 2 is an exploded perspective view of a touch screen according to a preferred embodiment of the present invention;

FIG. 3 is a cross-sectional view of the touch screen shown in FIG. 2; and

FIG. 4 is a cross-sectional view of the touch screen shown in FIG. 3, of which the positions of hardness dots are changed.

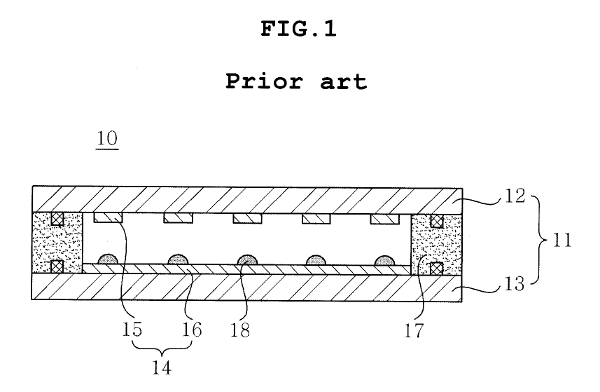

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, terms used in the specification, ‘first’, ‘second’, etc. can be used to describe various components, but the components are not to be construed as being limited to the terms. The terms are only used to differentiate one component from other components. Further, when it is determined that the detailed description of the known art related to the present invention may obscure the gist of the present invention, the detailed description thereof will be omitted.

Hereinafter, preferred embodiments according to the present invention will be described in detail with reference to the accompanying drawings.

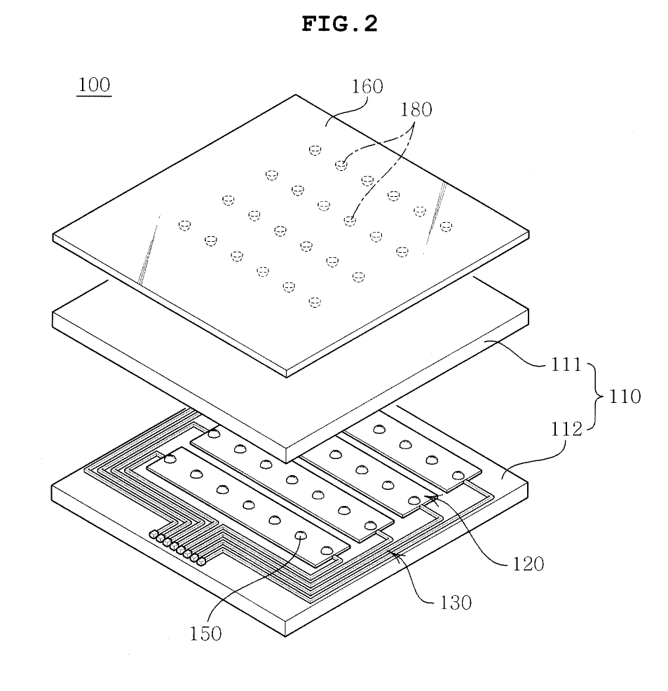

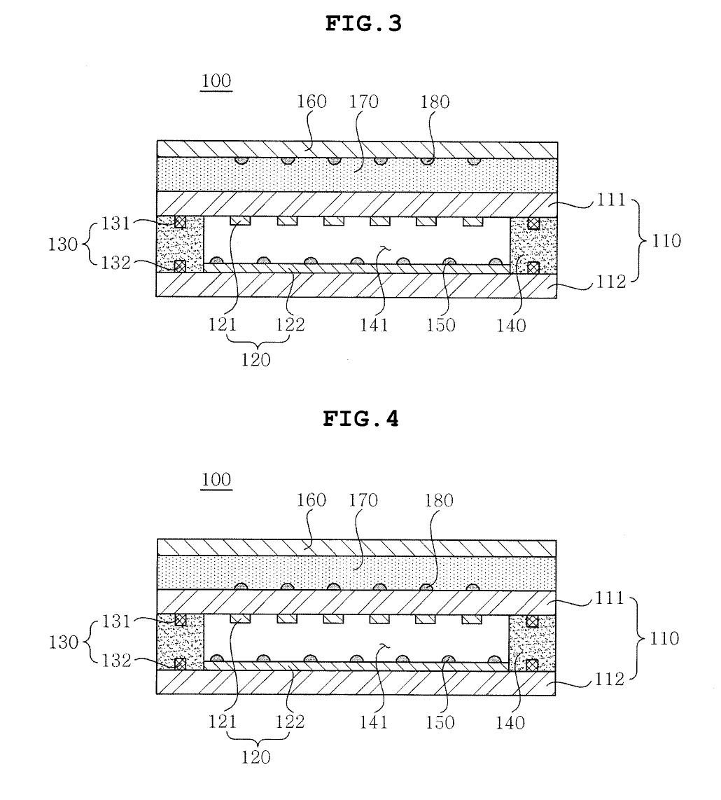

FIG. 2 is an exploded perspective view of a touch screen 100 according to a preferred embodiment of the present invention, and FIG. 3 is a cross-sectional view of the touch screen 100 shown in FIG. 2. The touch screen 100 according to the present embodiment is described with reference to the figures below.

Herein, the illustrations of a first adhesive layer 140 and a second adhesive layer 170 are omitted from FIG. 2 for convenience of explanation, but it is to be noted beforehand that the present invention may include the first adhesive layer 140 and the second adhesive layer 170.

As shown in FIGS. 2 and 3, the touch screen 100 according to the present embodiment includes transparent substrates 110, transparent electrodes 120, electrodes 130, the first adhesive layer 140, dot spacers 150, the second adhesive layer 170, a window plate 160 and hardness dots 180, wherein the hardness dots 180 compensates for the flexibility of the transparent electrodes 120, thereby lowering the operational load thereof,

The transparent substrates 110 may include two sheets of a first transparent substrate 111 and a second substrate 112.

In this case, the first transparent substrate 111 is a member to which pressure is applied through the window plate 160 from a specific object, such as a body of a user, a stylus pen, or the like. The first transparent substrate 111 has the first transparent electrode 121 formed on one surface thereof. Furthermore, since the first transparent substrate 111 is a member that can be bent when a pressure is applied thereto, it may be made of elastic material such that it may be returned to its original position when the pressure is released. The first transparent substrate 111 may be made of elastic and transparent material, for example, polyethylene terephthalate (PET), polycarbonate (PC), polymethylmethacrylate (PMMA), polyethylene naphthalate (PEN), polyethersulfone (PES), or cyclic olefin copolymer (COC) and have a film shape.

The second transparent substrate 112 is a member formed opposite to the first transparent substrate 111 and has the second transparent electrode 122 formed on one surface thereof. In this case, the second transparent substrate 112 may be made of the same transparent material as that of the first transparent substrate 111, but is not needed to be elastic like the first transparent substrate 111.

The transparent electrodes 120 are members each formed on the transparent substrates 110 and contacted with each other to detect signals of the touch input.

In this case, the transparent electrode 120 may be configured of the first transparent electrode 121 and the second transparent electrode 122, wherein the first transparent electrode 121 may be formed on one surface of the first transparent substrate 111 and the second transparent electrode 122 may be formed on one surface of the second transparent substrate 112 to be opposite to each other. Furthermore, the first transparent electrode 121 is contacted with the second transparent electrode 122 by pressure applied to the first transparent substrate 111 to cause change in voltage or resistance, which enables a controller (not shown) to sense the pressed coordinates and the controller recognizes the coordinates of the pressed positions to perform desired operations.

Furthermore, the first transparent electrode 121 and the second transparent electrode 122 may be formed to have the shape of bars which are orthogonal to each other to sense X axis and Y axis coordinates, respectively. It is not limited thereto, and may be formed to have various shapes, such as a diamond shape, a hexagonal shape, an octagonal shape, a triangular shape or the like. In this case, when the transparent electrodes 120 are patterned, a multi-touch may be implemented. In addition, when constructed according to analog resistive type, in the case where the transparent electrodes 120 may be formed in the shape of a film on the entire surface of the transparent substrate 110 except for the edges of the transparent substrate 110.

Meanwhile, the transparent electrodes 120 may be made of transparent material such that a user can see a lower display (not shown) and be made of conductive material The transparent electrode 120 may, for example, be made of a conductive polymer containing poly-3,4-ethylenedioxythiophene/polystyrenesulfonate (PEDOT/PSS), polyaniline alone or a mixture thereof, or metal oxides, such as indium tin oxide (ITO). In this case, when the transparent electrodes 120 are made of metal oxide, the transparent electrodes 120 may be coated on the transparent substrate 110 using deposition, development, etching, or the like, and when they are made of conductive polymer, the transparent electrodes 120 may be coated on the transparent substrate 110 using a silkscreen printing method, an inkjet printing method, a gravure printing method, an offset printing method, or the like.

The electrodes 130 are members which are electrically connected to the transparent electrodes 120 and apply voltage to the transparent electrodes 120.

In this case, each of the electrodes 130 includes a first electrode 131 and a second electrode 132, wherein the first electrode 131 may be formed to be connected to the first transparent electrode 121 on one surface of the first transparent substrate 111 and the second electrode 132 may be formed to be connected to the second transparent electrode 122 on one surface of the second transparent substrate 112 Furthermore, the electrodes 130 may be made of a material having excellent electrical conductivity such that voltage can be applied to the transparent electrodes 120. For example, the electrodes 130 may be made of a material composed of silver (Ag) paste or organic silver.

The first adhesive layer 140 is a member formed on the edges between one side surfaces of the transparent substrates 110 on which the transparent electrodes 120 are formed.

In this case, the first adhesive layer 140 may be configured by, for example, the double-sided adhesive tape (DAT), to bond the first transparent substrate 111 to the second transparent substrate 112. In addition, the first adhesive layer 140 may be formed between the edges of the transparent substrates 110 such that the first transparent electrode 212 and the second transparent electrode 122 can be in contact with each other by touch input between the insides of the transparent substrates 110. Therefore, an opening 141 may be formed in inner side of the first adhesive layer 140. Meanwhile, the electrodes 130 are formed on the edges of the transparent substrates 110 such that it is impregnated into the first adhesive layer 140.

The dot spacers 150 are members formed between the first transparent electrode 121 and the second transparent electrode 122 within the opening part 141 of the first adhesive layer 140.

In this case, the dot spacers 150 absorb impact when the first transparent electrode 121 and the second transparent electrode 122 are contacted with each other, and provide repulsive force such that the first transparent substrate 111 may be returned to its original position when pressure is released. In addition, the dot spacers function to maintain insulation between the transparent electrodes 120 at abnormal times such that the first transparent electrode 121 may not be contacted with the second transparent electrode 122 when there is no external pressure.

Furthermore, the dot spacers 150 may be formed internally between the first transparent substrate 111 and the second transparent substrate 122, that is, on the opening part 141 of the first adhesive layer 140. In this case, although, the dot spacers 150 are shown to be formed only on the second transparent electrode 122 in FIGS. 2 and 3, the present invention is not limited thereto, but the dot spacers may be formed only on the first transparent electrode 121 or on both the first transparent electrode 121 and the second electrode 122.

The window plate 160 is a member formed on the other surface of the first transparent substrate 111 having the first transparent electrode 121 formed thereon to protect other components of the touch screen 100.

In this case, the window plate 160 is a member to which is touched by a specific object, such as a body of a user or a stylus pen to directly receive input, which maintains the external form of the touch screen 100. Accordingly, the window plate 160 may be made of transparent material having durability large enough to sufficiently protect the touch screen 100 from external force such that a user can see the display well, such as polyethylene terephthalate (PET) or glass.

Meanwhile, the second adhesive layer 170 may be formed between the window plate 160 and the other surface of the first transparent substrate 111 (the surface opposite to the surface on which the first transparent electrode 121 is formed) so as to fix the window plate 160 and the first transparent substrate 111 each other. In this case, the second adhesive layer 170 is formed on entire surface between the window plate 160 and the first transparent substrate 111, and may be made of optical clear adhesive (OCA) by way of example.

The hardness dots 180 are formed on the window plate 160 and compensates for the flexibility of the transparent electrodes 120.

In this case, the hardness dots 180 may be formed to be protruded from one surface (surface to which the second adhesive layer 170 is adhered) of the window plate 160 to be impregnated into the second adhesive layer 170. However, the hardness dots 180 do not always need to be formed on one surface of the window plate 160. FIG. 4 is a cross-sectional view of the touch screen as shown in FIG. 3, of which the positions of hardness dots are changed and as shown in FIG. 4, the hardness dots 180 may be formed on the other surface (the surface opposite to the surface on which the first transparent electrode 121) of the first transparent substrate 111.

Meanwhile, the hardness dots 180 may be alternately arranged with respect to the dot spacers 150. Herein, the meaning of “alternately arranged” is that, when lines perpendicular to the dot spacers 150 are traced out, the hardness dots 180 are each located between the perpendicular liens.

Furthermore, a plurality of hardness dots 180 is arranged on entire surface of the window plate 160, and thus may be made of transparent material. Furthermore, the hardness dots may be made of a material having sufficient hardness such that the pressure of touch input may be concentrated on the first transparent electrode 121. The hardness dots 180 may be made of rigid resin, such as, acryl, urethane resin, or siloxane-based resin or the like. Furthermore, the height of the second adhesive layer 170 is about 50 μm, so that the hardness dots 180 may be formed to have the height of about 15 μm that is lower than that of the second adhesive layer 170. However, it is to be noted that the present invention is not limited thereto.

Meanwhile, the hardness dots 180 may compensate for the flexibility of the first transparent electrode 121 to lower the operational load of the touch screen 100. Generally, although the first transparent electrode 121 is contacted with the second transparent electrode 122, touch signals may be detected only when force above predetermined force is applied thereto. In particular, when the transparent electrode 120 is made of conductive polymer, relatively larger operational load is required due to the flexibility of the conductive polymer. In this case, when the hardness dots 180 are formed, the hardness dots 180 concentrate the force of touch input and deliver it to the first transparent electrode 121, so that even though a user applies less force compared to the case where the hardness dots 180 are not formed, a controller (not shown) can sense touch signals. That is, when the hardness dots 180 are formed, force can be concentrated, thereby lowering operational load. Furthermore, when the hardness dots 180 and the dot spacers 150 are alternately arranged, the hardness dots can concentrate force on a point where the first transparent electrode 121 is contacted with the second transparent electrode 122 more efficiently, which is desired.

In the touch screen according to the present invention, the hardness dots which concentrate the force of touch input and deliver it to the transparent electrode are formed on the window plate, thereby lowering the operational load of the transparent load.

Furthermore, according to the present invention, the operational load can be lowered by the hardness dots, so that the touch input does not need to be applied with large force, thereby preventing the window plate and the transparent substrates from being damaged.

Furthermore, according to the present invention, the hardness dots and the dot spacers are alternately arranged, so that the hardness dots can more efficiently concentrate force on a point where the first transparent electrode and the second transparent electrode are contacted with each other to deliver it to the transparent electrodes by a touch input.

Although the preferred embodiments of the present invention have been disclosed for illustrative purposes, they are for specifically explaining the present invention and thus a touch screen according to the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A touch screen, comprising:
a first transparent electrode formed on one surface of a first transparent substrate;
a second transparent electrode formed on one surface of a second transparent substrate;
a first adhesive layer configured to adhere an edge of one surface of the first transparent substrate and an edge of one surface of the second transparent substrate to each other;
a second adhesive layer formed on the other surface of the first transparent substrate;
a window plate adhered to the first transparent substrate through the second adhesive layer; and
hardness dots formed on one surface of the window plate adhered to the second adhesive layer or the other surface of the first transparent substrate,
wherein the first transparent electrode and the second transparent electrode are contacted with each other upon occurrence of touch input, and sense changes in resistance or voltage.

2. The touch screen as set forth in claim 1, further comprising dot spacers formed between the first transparent electrode and the second transparent electrode.

3. The touch screen as set forth in claim 1, wherein the first transparent electrode or the second transparent electrode includes a conductive polymer.

4. The touch screen as set forth in claim 2, the hardness dots and the dot spacers are alternately arranged.

5. The touch screen as set forth in claim 2, the dot spacers are formed on the first transparent electrode or the second transparent electrode.
